(19) United States
(12) Patent Application Publication
(10) Pub. No.: US 2024/0300677 A1
(43) Pub. Date: Sep. 12, 2024

(54) DEPLOYABLE LUNAR LANDING PADS FOR SPACE MINING APPLICATIONS

(71) Applicant: Trans Astronautica Corporation, Lake View Terrace, CA (US)

(72) Inventors: Joel C. Sercel, Lake View Terrace, CA (US); James G. Small, Sonoita, AZ (US)

(21) Appl. No.: 17/586,268

(22) Filed: Jan. 27, 2022

Related U.S. Application Data
(60) Provisional application No. 63/142,868, filed on Jan. 28, 2021.

(51) Int. Cl. B64G 1/62; B64G 1/22

(52) U.S. Cl. CPC B64G 1/623; B64G 1/2225

(57) ABSTRACT

Deployable lunar landing pads for space mining applications are disclosed. In one aspect, a landing pad for deployment on a celestial body includes a deployable surface configured to be stored in a stowed configuration on a spacecraft and be deployed into a deployed configuration on a surface of the celestial body, a landing system configured to land the landing pad on the surface of the celestial body, and a control system configured to control the landing system during landing of the landing pad on the surface of the celestial body and control the deployment of the deployable surface. The deployable surface is further configured to reduce or eliminate scattering of loose material from the surface of the celestial body in the deployed configuration.

### INCORPORATION BY REFERENCE TO ANY PRIORITY APPLICATION(S)

This application is based upon and claims the benefit of priority from U.S. Provisional Patent Application No. 63/152,868 filed on Jan. 28, 2021. Moreover, any and all applications for which a foreign or domestic priority claim is identified in the Application Data Sheet as filed with the present application are hereby incorporated by reference under 37 CFR 1.57. The entire contents of each of the above-listed item(s) is hereby incorporated into this document by reference and made a part of this specification for all purposes, for all that each contains.

### BACKGROUND

### Technological Field

The present system relates to preparing rocket landing sites on the Moon or other celestial bodies mitigate or address dangers from loose surface materials.

### SUMMARY OF CERTAIN INVENTIVE ASPECTS

### Problem

When a spacecraft performs a soft landing on the Moon or another celestial body, it must use a downward-directed braking rocket to reduce its touchdown speed. Near the lunar surface, the powerful exhaust from the rocket plume causes loose material on the surface to be blown away in all possible directions at very high speed. In this minimal gravity and atmosphere environment, small particles, grains of sand and loose gravel can be propelled at speeds up to several thousands of meters per second. These speeds may be two to three times faster than a typical rifle bullet fired on Earth. Nearby structures are at risk of penetration damage due to the high-speed particles colliding with such structures.

With the absence of air friction and the low lunar gravity, particles become projectiles that often blast high above the ground, only to return later at extreme speeds and energy. Some particles can be propelled into lunar orbit and may circle the entire Moon before again striking the lunar surface. These high-speed particles can present a serious damage hazard to near or distant man-made structures previously landed and/or constructed on the Moon. The problem is particularly dangerous for landers that touch down near the lunar poles. Due to the low rotational velocity of the polar regions, the particles have a high probability of striking very near to their launch points. They may ultimately strike the lander which launched them as well as any nearby structures, even if the lander or nearby structures are not hit by the initial launch of the particles.

A method is needed to provide landing pads or other structures for incoming spacecraft that will be free from loose surface materials and/or can significantly reduce the dispersion or propelling of lunar particles during launch/take off. Eventually, lunar surface operations will be able to construct paved spaceports from available lunar materials. For early landers and for landing in previously unexplored regions, it is desirable to deploy landing pads directly from incoming space assets.

While other methods of deploying a landing pad from a spacecraft have been proposed, none are intended for multiple landings and very few are deployed prior to landing. One is the Masten FAST technology, which is a spray injected into the lander's exhaust to form a coating that traps any loose surface material beneath it. Another is the PocketPad, which is a large piece of fabric surrounded by an inflatable ring. These methods are not intended to survive repeated landings. A mobile helipad, the Mobi-mat TAHEL product line, uses a heavy fabric to prevent loose surface material from being blown into the air. However, TAHEL mobile helipads are deployed by a ground crew before helicopters attempt to land. A disadvantage of the Masten approach and some other approaches is that it requires the landing spacecraft to hover while the pad is deployed. Other concepts require at least one vehicle to be landed to deploy pads for subsequent landers.

Described herein is an approach in which a self-contained landing pad system is deployed either from the spacecraft which is to land, or from another spacecraft prior to the landing event. According to certain aspects, a landing pad described herein contains rocket motors or other landing technology that allows it to land itself without support from the landing spacecraft. Once landed on the ground, the landing pad can deploy a flat structure for the landing spacecraft to use. The landing pad can be deployed many orbits before the landing spacecraft or shortly before the landing spacecraft or even while the landing spacecraft is hovering or descending, but this is not required.

### BRIEF DESCRIPTION OF THE DRAWINGS

FIG. 1 illustrates a spacecraft which deploys a flexible landing pad toward the lunar surface prior to its touchdown.

FIG. 2 is a block diagram illustrating a landing pad 20 in accordance with aspects of this disclosure.

### DETAILED DESCRIPTION

The present system describes methods and implementations to provide for safe landing pads on the lunar surface or on the surface of another celestial body. In the descriptions below, the landing pad is described as made from a large continuous membrane or large closely woven blanket of relatively low-density material that can be unfurled from a spacecraft. In other implementations, the landing pad can also be made of hinged and/or motorized flat plates made of metal and/or ceramic that are made to automatically unfurl and/or fold out after the landing pad has landed.

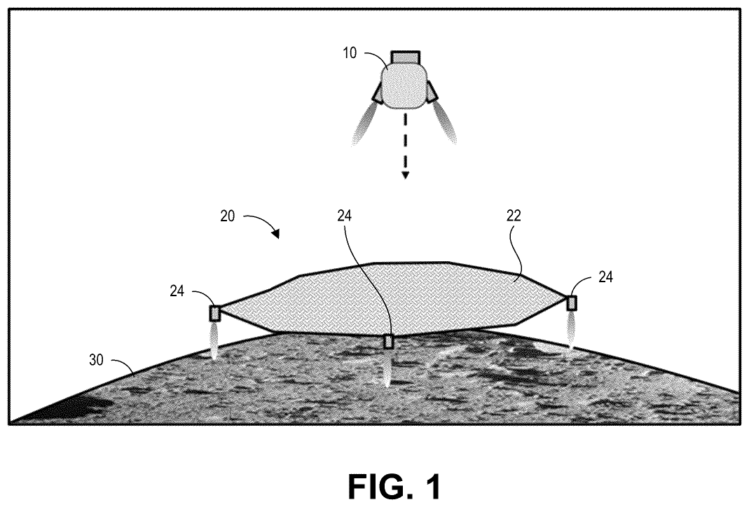

FIG. 1 illustrates an approaching spacecraft 10 configured to deploy a flexible or rigid landing pad 20 with a deployable surface 22 toward the lunar surface 30 prior to touchdown. Depending on the embodiment, the deployable surface 22 may be flexible, rigid, or have a combination of flexible and rigid parts.

The landing pad 20 can include braking thrusters 24 configured to slow the landing pad's descent. The braking thrusters 24 may be relatively small to prevent launching lunar particles when a sufficient distance from the lunar surface 30. In other words, the amount of thrust provided by the braking thrusters 24 is configured to be small enough to reduce or prevent launching lunar particles when further away from the lunar surface than a threshold distance. The braking thrusters 24 are configured to shut down a threshold distance (e.g., several meters) above the lunar surface 30 to prevent or reduce the amount of loose material scattered by the braking thruster's 24 exhaust plumes. The main spacecraft 10 can then land normally on the landing pad 20, which reduces debris scattered from the more powerful rocket plume. That is, the deployed surface 22 of the landing pad 20 can block, absorb, or receive at least a portion of the rocket plume from the spacecraft 20, thereby reducing or eliminating scattering of debris that would result if the landing pad 20 were not present. The spacecraft 10 can also launch from the landing pad 20 back into space and other spacecraft can subsequently use the landing pad 20 in the same or a similar way to reduce or eliminate the scattering of lunar debris.

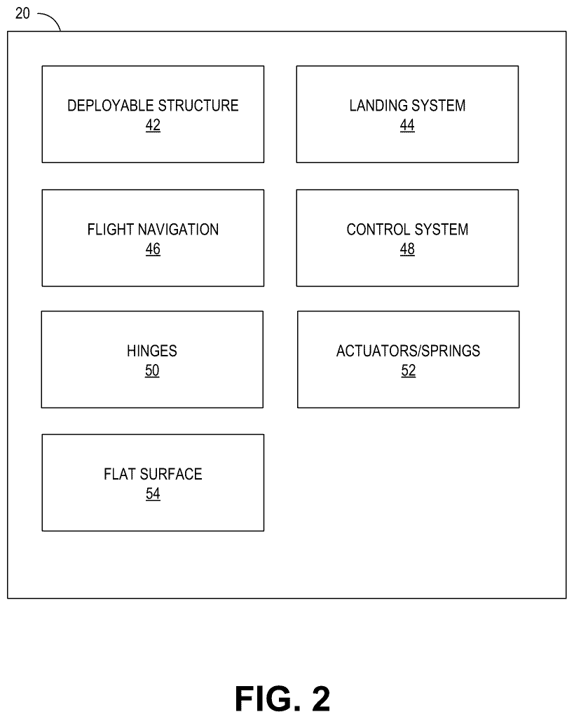

FIG. 2 is a block diagram illustrating a landing pad 20 in accordance with aspects of this disclosure. In the illustrated embodiment, the landing pad 20 comprises a deployable structure 42 including a landing system 44 (e.g., one or more rocket engines) as well as a flight navigation system 46 and a control system 48. Prior to deployment from the spacecraft 10, the deployable structure 42 is configured to start off in a stowed configuration. The landing pad 20 can be launched, ejected, or unfurled from the spacecraft 10 in the stowed configuration. The rocket engines, or other landing system 44, can be configured to land the landing pad 20 onto the surface in the stowed configuration. After landing, the landing pad 20 can be deployed/unfolded into the landing pad 20 full size. Alternatively, a descending or landing movement (e.g., resistance from ground impact, etc.) can be used to overcome spring tension or otherwise help expand or otherwise deploy the pad. To aid in deployment, the landing pad 20 can include hinges 50 driven by actuators and/or springs 52 configured to unfold the landing pad 20. The unfolding of the landing pad 20 may have a simple unfolding pattern (e.g., like flower pedals opening) or a comparatively more complex unfolding pattern (e.g., like unfolding an origami pattern). The landing pad 20 can include flat surfaces 54 between the hinges 50, which can be formed of rigid metallic, ceramic or other types of panels, or can be formed of more exotic fabrics or shape memory materials in some implementations.

In a first embodiment, a landing pad 20 is deployed from a spacecraft 10 above the lunar surface 30. The spacecraft 10 may be on a direct path towards the lunar surface 30 or the spacecraft 10 may be on a passing orbit. The landing pad 30 is unfurled from a stowed position on the spacecraft 10 by any of several means either before landing on the lunar surface 30 or thereafter. In some implementations of the first embodiment, the landing pad 20 can be caused to rotate and centrifugal forces are used to spread out the deployable surface 22 of the landing pad 20 into a deployed configuration. In some implementations, the landing pad 20 can include shape memory materials imbedded therein, which are configured to cause the deployable surface 22 of the landing pad 20 to spread out after the landing pad 20 is released from storage. In some implementations, thrusters (e.g., similar to the braking thrusters 24) disposed around the circumference of the landing pad 20 are configured to provide forces to unfurl the pad material forming the deployable surface 22 of the landing pad 20. In some implementations, a ground impact force is used to reconfigure a landing pad (e.g., similar to an umbrella, where ground impact is used to extend radial struts, with or without the aid of a spring).

Continuing to refer to the first embodiment, when the spacecraft 10 is on a direct path towards the lunar surface 30, the deployed landing pad 20 can be released directly from the spacecraft 10. The landing pad 20 can then proceed directly to a touch down area on the lunar surface 30 where the landing pad 20 will impact with more or less velocity (e.g., depending on the initial velocity of the landing pad 20 at release and its altitude or distance of fall to the lunar surface 30). In some embodiments, the landing pad 20 is constructed of material with sufficiently low density such that the impact forces over each unit area of the landing pad 20 material may be quite low compared to the impact forces of the spacecraft 10. The landing of the landing pad 20 may be analogous to dropping a feather or a silk fabric onto a rough surface. The landing pad 20 may be decelerated by means of attached braking thrusters 24. When the landing pad 20 is a distance (e.g., a predetermined or sensed distance) above the lunar surface 30, the braking thrusters 24 may be configured to shut down or otherwise adjust to reduce or prevent scattering of loose surface material due to braking thrusters 24. Through the final approach (e.g., the last few meters or another predetermined distance) above the lunar surface 30, the landing pad 20 may fall freely in the relatively low lunar gravity.

In some embodiments, after release of the landing pad 20, the spacecraft 10 and the landing pad use active measures (e.g., thrusters or other mass displacement techniques) to change their relative positions, speeds, alignment, and/or orientations such that the landing pad 20 arrives at the surface 30 a sufficient time before the spacecraft 10. For example, the spacecraft 10 may decelerate, and/or the landing pad may temporarily accelerate, to cause separation between the spacecraft 10 and the landing pad 20. For example, after a spacecraft can eject a landing pad, then decelerate by firing braking rockets while the landing pad continues to descend. A certain time later (e.g., a few seconds later), the spacecraft 10 can fire braking rockets in a pattern such that the spacecraft 10 lands softly on the previously-landed landing pad 20.

In the case where the spacecraft 10 is in a passing orbit over the surface 30 of the Moon (in contrast to a more vertical or orthogonal descent, for example), the unfurled landing pad 20 can be provided with braking and/or orienting rockets 24 to reduce its tangential velocity over the lunar surface and/or re-orient itself with respect to the local surface. The landing pad 20 can then fall directly toward the surface 30 as in the process described above.

In some embodiments, the landing pad 20 is deployed from a spacecraft 10 after the spacecraft 10 has completed a landing on the surface 30 of the Moon. In some situations, it is expected that much loose material will be blown away during the landing of the spacecraft 10. The landing pad 20 can be used to prepare the landing site (or additional, e.g., adjacent, sites) for future spacecraft landing events.

In some implementations, the landing pad 20 and the deployment mechanism of the landing pad 20 may be packaged as a deployable payload from a multi-purpose spacecraft mission. Before or after landing, the payload can be detached from the spacecraft lander and mechanisms in the payload can be used to deploy the landing pad 10. In some implementations, the landing pad can be packaged for separate impact using a deployable or static balloon or other cushion or bumper.

In some implementations, the spacecraft 10 is a specialized lander dedicated to a single mission to deliver and deploy the landing pad 20. Upon landing, the lander can proceed directly to the task of deploying the landing pad 20. For example, the lander can comprise or transform into the landing pad, such that a first spacecraft becomes a landing pad for a second (and potentially additional) spacecraft.

The particular landing systems 44 used for the landing pad 20 may be selected based on a variety of factors, including the atmosphere and gravity of the celestial body onto which the landing pad 20 is designed to be deployed. For example, on celestial bodies having a significant atmosphere, a parachute type landing system 44 may be used to slow the decent of the landing pad 20 to speeds that will not damage the landing pad 20 when released from the spacecraft in orbit or high above the surface. As another example, when the gravity of the celestial body is low enough, the landing pad 20 may employ a landing system 44 can simply include a balloon, cushion, and or bumper without the need for more sophisticated landing gear.

Another embodiment of a landing pad includes a large weight-bearing platform, such as an inflatable structure. As described herein, spacecraft which land or depart from the lunar surface or from the surface of asteroids are known to disperse high-speed sand and gravel particles in various directions due to blast from rocket engines or other propulsion systems. Blasted or dispersed surface ejecta can reach high velocities in low gravity and/or thin atmosphere conditions such as that of Earth's moon (e.g., above 1000 m/s). The ejecta can damage nearby and even distant facilities. A suggested mitigation method is to require that routine spacecraft operations be conducted only from prepared landing fields or other landing structures. Elevating, erecting, inflating, or widening a landing pad, e.g. an inflatable structure, can block or deter powerful rocket plumes from disturbing underlying surface regolith. Thus, a landing pad or inflatable structure that will shield surface regolith can be constructed without the need to pave, clear, or otherwise modify large areas of the lunar surface. Accordingly, in certain embodiments, a landing pad for spacecraft can be advantageously located on an inflatable structure (e.g., at the top of an inflatable tower, far above the underlying regolith) in order to reduce or eliminate the generation of ejecta during spacecraft landing/liftoff. Special materials can be used on or near the surface (or to form, coat, or otherwise protect the top layer of an inflatable) to avoid melting and other harmful effects. For example, a top plate on an inflatable structure such as a tower can be large and formed from relatively smooth, sturdy and/or inflammable materials. Additional details on inflatable structures and how to use and erect them in a moon-type environment are disclosed in U.S. patent application Ser. No. 17/574,462, filed Jan. 12, 2022, the entire disclosure of which is incorporated herein for all purposes, for all that it contains.

### Example Methods of Landing a Landing Pad

The landing pad 20 may use various different methods or techniques for landing on a surface of a celestial body (e.g., such as the lunar surface). A non-exhaustive list of example methods and steps are provided below. A method of deploying a landing pad can include: deploying the landing pad from a spacecraft before the spacecraft reaches a surface of a celestial body; deploying a deployable surface of the landing pad on the surface of the celestial body, the deployable surface configured to cover and contain or immobilize loose material from the surface of the celestial body before and/or during arrival of the spacecraft.

The deployment of the deployable surface is performed before or as the landing pad arrives at the surface of the celestial body.

The deployment of the deployable surface is performed after the landing pad arrives at the surface of the celestial body.

The deployable surface is formed of a flexible membrane and/or fabric (e.g., a tightly woven fabric).

The deployment of the deployable surface comprises unfolding or unfurling the deployable surface. The deployment can occur, for example, by rotating the deployable surface to generate centrifugal forces after detaching the landing pad from the spacecraft.

The deployment can occur using a spring or jolt-initiated movement, as supporting arms extend using the force of impact as a directional energy source.

The deployment of the deployable surface comprises unfurling the deployable surface using one or more shape memory materials.

The deployment of the deployable surface comprises unfurling the deployable surface using one or more thrusters. These thrusters can be disposed about the circumference of the deployable surface, for example.

The method further includes decelerating and/or orienting the landing pad before touchdown using one or more braking thrusters.

The method further includes shutting down or adjusting power or direction of the braking thrusters a above the surface of the celestial body to allow the landing pad to descend (e.g., in free-fall) under gravity of the celestial body.

The deployable surface can be formed of a polymer liquid configured to harden upon contact with the lunar surface and bind to and immobilize loose surface material.

Some methods include: landing a multi-mission spacecraft upon a lunar surface; detaching a mobile machine from the spacecraft; and deploying a landing pad material over a landing area adjacent to the spacecraft.

Some methods include: landing a spacecraft upon a landing site of a lunar surface, the spacecraft comprising a landing pad material and a mobility means; and moving the spacecraft about the lunar surface while deploying the landing pad material either adjacent to the landing site or at a location distant from the landing site.

### CONCLUSION

Unless the context clearly requires otherwise, throughout the description and the claims, the words “comprise.” “comprising.” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below.” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might.” “can.” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description is not intended to be exhaustive or to limit the invention to the precise form disclosed above. While specific embodiments of, and examples are described above for illustrative purposes, various equivalent modifications are possible within the scope of the disclosed invention(s), as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings provided herein can be applied to other systems, not necessarily the system described above. The elements and acts of the various embodiments described above can be extracted, subdivided, and/or combined to provide further embodiments.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising.” “including.” “having.” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Embodiments of the disclosed systems and methods can be used and/or implemented with local and/or remote devices, components, and/or modules. The term “remote” may include devices, components, and/or modules not stored locally. Thus, a remote device may include a device which is physically located in the same general area and connected via a device such as a switch or a local area network. In other situations, a remote device may also be located in a separate geographic area, such as, for example, in a different location, building, valley, and so forth.

A number of applications, publications, and external documents may be incorporated by reference herein. Any conflict or contradiction between a statement in the body text of this specification and a statement in any of the incorporated documents is to be resolved in favor of the statement in the body text.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. A landing pad for deployment on a celestial body, comprising:
a deployable surface configured to be stored in a stowed configuration on a spacecraft and be deployed into a deployed configuration on a surface of the celestial body;
a landing system configured to land the landing pad on the surface of the celestial body; and
a control system configured to control the landing system during landing of the landing pad on the surface of the celestial body and control the deployment of the deployable surface,
wherein the deployable surface is further configured to reduce or eliminate scattering of loose material from the surface of the celestial body in the deployed configuration.

2. The landing pad of claim 1, wherein the landing system comprises:
one or more braking thrusters configured to slow the landing pad's descent during landing of the landing pad.

3. The landing pad of claim 2, wherein the one or more braking thrusters are further configured to shut down a threshold distance above the surface of the celestial body to reduce or prevent the loose material from being scattered by exhaust plumes from the braking thruster.

4. The landing pad of claim 2, wherein the one or more braking thrusters are further configured to provide an amount of thrust that is small enough to reduce or prevent the loose material from being scattered by the braking thruster's exhaust plumes when the landing pad is greater than a threshold distance from the surface of the celestial body.

5. The landing pad of claim 1, wherein the deployable surface is configured to be used for landing of a plurality of spacecraft.

6. The landing pad of claim 1, wherein the landing system is further configured to unfurl the deployable surface before landing on the surface of the celestial body.

7. The landing pad of claim 6, wherein the landing system is further configured to cause the deployable surface to rotate such that centrifugal forces spread out the deployable surface into the deployed configuration.

8. The landing pad of claim 6, wherein the landing system comprises one or more shape memory materials configured to cause the deployable surface to spread out into the deployed configuration after the landing pad is released from storage on the spacecraft.

9. The landing pad of claim 6, wherein the landing system comprises one or more thrusters configured to provide forces to unfurl the deployable surface.

10. A method of deploying a landing pad, comprising:
deploying the landing pad from a spacecraft before the spacecraft reaches a surface of a celestial body;
deploying a deployable surface of the landing pad on the surface of the celestial body, the deployable surface configured to cover and immobilize loose material from the surface of the celestial body before arrival of the spacecraft.

11. The method of claim 10, wherein the deployment of the deployable surface is performed before the landing pad arrives at the surface of the celestial body.

12. The method of claim 10, wherein the deployment of the deployable surface is performed using forces and momentum from the landing process as the landing pad arrives at the surface of the celestial body.

13. The method of claim 10, wherein the deployable surface is formed of a flexible membrane and/or a tightly woven fabric.

14. The method of claim 13, wherein the deployment of the deployable surface comprises unfurling the deployable surface by rotating the deployable surface to generate centrifugal forces after detaching the landing pad from the spacecraft.

15. The method of claim 13, wherein the deployment of the deployable surface comprises unfurling the deployable surface using one or more shape memory materials.

16. The method of claim 13, wherein the deployment of the deployable surface comprises unfurling the deployable surface using one or more thrusters disposed about the circumference of the deployable surface.

17. The method of claim 13, further comprising:
decelerating the landing pad before touchdown using one or more braking thrusters.

18. The method of claim 17, further comprising:
shutting down the braking thrusters a predetermined distance above the surface of the celestial body to allow the landing pad to free-fall under gravity of the celestial body.

19. The method of claim 10, wherein the deployable surface is formed of a polymer liquid configured to harden upon contact with the lunar surface and bind to and immobilize loose surface material.

20. A method, comprising:
landing a multi-mission spacecraft upon a lunar surface;
detaches a mobile machine from the spacecraft; and
deploying a landing pad material over a landing area adjacent to the spacecraft.

21. A method, comprising:
landing a spacecraft upon a landing site of a lunar surface, the spacecraft comprising a landing pad material and a mobility means;
moving the spacecraft about the lunar surface while deploying the landing pad material either adjacent to the landing site or at a location distant from the landing site.
